(19) United States
(12) Patent Application Publication
(10) Pub. No.: US 2026/0017583 A1
(43) Pub. Date: Jan. 15, 2026

(54) INTEGRATED ENERGY SYSTEM OPTIMIZED DISPATCHING METHOD BASED ON VARIABLE TIME CONSTANT GRADIENT ALGORITHM

(71) Applicant: Hangzhou Dianzi University, Hangzhou (CN)

(72) Inventors: Lingwei ZHENG, Hangzhou (CN); Bingqiang XU, Hangzhou (CN); Heng WANG, Hangzhou (CN); Sa YAO, Hangzhou (CN); Gaoxuan CHEN, Hangzhou (CN)

(21) Appl. No.: 19/094,907

(22) Filed: Mar. 30, 2025

(30) Foreign Application Priority Data
Jul. 12, 2024 (CN) 202410931964.1

(51) Int. Cl. G06Q 10/0631; G06N 3/08; G06Q 50/06

(52) U.S. Cl. CPC G06Q 10/06313; G06N 3/08; G06Q 50/06

(57) ABSTRACT

Disclosed is an integrated energy system optimized dispatching method based on a variable time constant gradient algorithm. A Markov decision making process model is established based on an economic dispatching characteristic of an integrated energy system first, and a target optimization function is established. Then, a neural network is established and trained by applying a double-delay depth deterministic strategy gradient algorithm, effective experience is determined before updating a target network, and a variable time constant is set according to a reward value of a current round and a reward value of the last round of soft update. Finally, a trained intelligent agent is used for intra-day dispatching of the integrated energy system, so as to realize optimal economic cost operation of the integrated energy system.

### CROSS REFERENCE TO RELATED APPLICATIONS

This application claims foreign priority of Chinese Patent Application No. 202410931964.1, filed on Jul. 12, 2024 in the China National Intellectual Property Administration, the disclosures of all of which are hereby incorporated by reference.

### TECHNICAL FIELD

The present invention belongs to the technical field of new energy, and relates to energy dispatching optimization, and particularly to an integrated energy system optimized dispatching method based on a variable time constant gradient algorithm.

### BACKGROUND OF THE PRESENT INVENTION

Integrated energy system is a system that integrates various energy sources such as coal, oil, natural gas, electric energy and thermal energy in a region to realize coordinated planning, optimized operation, collaborative management, interactive response and mutual assistance among various heterogeneous energy subsystems. For an integrated energy system with a relatively stable structure, it is necessary to effectively improve the energy utilization efficiency and promote the sustainable development of energy while meeting diversified energy consumption demands in the system.

Dynamic planning is the most commonly used integrated energy system optimized dispatching model, and in the case that the model structure is not complicated, the dynamic planning algorithm can greatly improve the solving efficiency. However, when the integrated energy system model is complex, it takes a lot of time to solve the model by the dynamic planning. Compared with the dynamic planning algorithm, a genetic algorithm can obtain a calculation result faster and may be used in the integrated energy system with the complex model. However, a solution result of the genetic algorithm is seriously affected by parameters such as a crossover rate and a mutation rate, and these parameters are mostly selected according to experience. In addition, the genetic algorithm also depends on the selection of initial population, so that the genetic algorithm still has some limitations in solving the integrated energy system optimized dispatching problem.

Compared with the above traditional dispatching method, reinforcement learning, as a sub-field of machine learning, optimizes a decision by a feedback obtained from interactive learning and training between an intelligent agent and an environment. When the integrated energy system optimized dispatching is carried out by the reinforcement learning algorithm, an operation cost can be effectively reduced. However, with the diversification of units and the increasing complexity of energy coupling, the reinforcement learning algorithm based on discrete control will inevitably suffer from the “curse of dimensionality” brought by an exponential increase of action discretization. Although the continuous action reinforcement learning algorithm can avoid the defects of the discrete action reinforcement learning algorithm in the integrated energy system optimized dispatching, there are also some problems of overestimation, low execution efficiency, and the like.

In practical application, people often only pay attention to how to improve the algorithm to reduce the operation cost of the system, and usually simplify or even avoid the problem of model training efficiency, resulting in a waste of a lot of computing resources, which is not conducive to increasing an operation income and a model training cost of the integrated energy system to the greatest extent under fixed hardware configuration conditions.

### SUMMARY OF THE PRESENT INVENTION

Aiming at the defects in the prior art, the present invention provides an integrated energy system optimized dispatching method based on a variable time constant gradient algorithm, wherein a time constant is set to be updated in real time with a feedback from an environment, so that an update weight of a target network can be flexibly adjusted according to a current system state, and a convergence speed of a model is increased. The quality of past experience is judged, which effectively solves the problem of low effective experience utilization efficiency when a double-delay depth deterministic strategy gradient algorithm is used for integrated energy system optimized dispatching.

According to the integrated energy system optimized dispatching method based on the variable time constant gradient algorithm, after determining an objective function of the system, training of an intelligent agent comprises the following steps.
In step 1, an integrated energy system model is established, an optimized dispatching process for the model is described as a Markov decision making process, parameters of a neural network are initialized, and an experience pool is filled by exploratory initialization.
In step 2, parameters of a value network are updated by a gradient descent algorithm.
In step 3, on the basis of delayed learning, an update frequency of a strategy network π(s|ϕ) is set to be less than that of a value network Q_{θ}_{ᵢ}(s, a|θᵢ), and the strategy network is updated by a gradient ascent algorithm.

In step 4, a reward value rₜ of a current round is compared with a reward value rₜ₋₃ of the last round of soft update, and a variable time constant τₜ is set:

$${τ}_{t} = \{ \begin{matrix}{τ}_{t - 3} + ρ & ( {r}_{t} < {r}_{t - 3} ) \\ {τ}_{t - 3} & ( {r}_{t} = {r}_{t - 3} ) \\ {τ}_{t - 3} - ρ & ( {r}_{t} > {r}_{t - 3} )\end{matrix}$$

wherein, τₜ₋₃ is a variable time constant used in the last round of update, τ₀=0.005, and ρ is a variation of the time constant; and t represents an update moment of the current round of the target network, and t−3 represents an update moment of the last round of the target network.

A target strategy network and a target value network are updated according to the variable time constant τₜ of the current round.
In step 5, according to the steps 2 to 4, the intelligent agent is repeatedly iteratively trained to learn how to make the best decision in different situations, so as to maximize a reward function.
In step 6, the trained intelligent agent is used for intra-day dispatching of the integrated energy system, so as to realize optimal economic cost operation of the integrated energy system.

The present invention has the following beneficial effects.
1. The method for judging effective experience in soft update of the target network is provided, wherein a reward value in soft update is compared with a reward value in the last soft update, and a target network parameter corresponding to the larger reward value is the effective experience in integrated energy system dispatching, so that the target network uses less inferior experience and more superior experience, which solves the problem of low effective experience utilization efficiency when the double-delay depth deterministic strategy gradient algorithm is used for integrated energy system optimized dispatching.
2. The integrated energy system real-time dispatching method based on the soft update method of the variable time constant is provided, which improves the problem of fixed time constant in soft update in a traditional network training process, and the time constant is set to be updated in real time with a feedback from an environment, so that an update weight of the target network can be flexibly adjusted according to a current system state, and a convergence speed of the model is increased.
3. Considering a change of load demand in different seasons, an integrated energy system operation cost model composed of four sub-items is provided, which is more in line with actual application, and the trained intelligent agent is used for the intra-day dispatching of the integrated energy system, which can significantly reduce the operation cost of the integrated energy system.

### DESCRIPTION OF THE DRAWINGS

FIG. 1 is a schematic structural diagram of an integrated energy system dispatched in an embodiment;

FIG. 2 is a flow chart of initialization of a neural network and an experience pool;

FIG. 3 is a flow chart of soft update of a variable time constant;

FIG. 4 is a flow chart of training of a model; and

FIG. 5 shows a test result of a convergence performance of the model in the embodiment.

### DETAILED DESCRIPTION OF PREFERRED EMBODIMENTS

The present invention is further explained and described hereinafter with reference to the drawings.

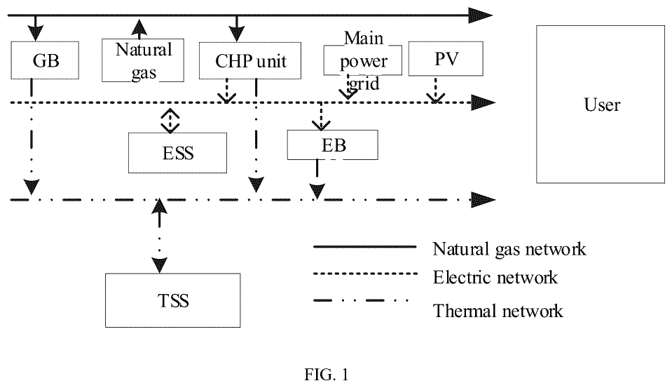

According to an integrated energy system optimized dispatching method based on a variable time constant gradient algorithm, an objective function is set as an operation cost of each unit. An integrated energy system selected in the embodiment comprises energy supply, storage and consumption units, such as a photovoltaic power generation device, a cogeneration unit, a gas boiler, an electric boiler, an electricity storage system and a heat storage system, which are connected to a main power grid, and an overall structure is as shown in FIG. 1. The following optimized objective function is established for the integrated energy system:

$$F = min {\sum }_{t}^{T} ( {C}_{E} ( t ) + {C}_{C H P} ( t ) + {C}_{E S S} ( t ) + {C}_{G B} ( t ) )$$

wherein, C_{E}(t), C_{CHP}(t), C_{ESS}(t) and C_{GB}(t) are respectively an electricity purchasing cost, a cogeneration cost, an energy storage system operation cost and a gas boiler operation cost at the moment t, in a unit of $; and T is a step number of time in a single dispatching period.

The integrated energy system must meet constraints on corresponding device and external energy supply of the system during operation, and these constraints comprise an electric power balance constraint, a thermal power balance constraint, a cogeneration unit operation constraint, an electricity storage system operation constraint, a heat storage system operation constraint, a main power grid electricity purchasing constraint, an electric boiler constraint and a gas boiler constraint.

One dispatching period of the integrated energy system is set as 24 hours, and one dispatching time interval is set as 1 hour. The integrated energy system above is dispatched according to the following steps.

In step 1, an optimized dispatching reinforcement learning framework of the integrated energy system is described as a Markov decision making process, and a state space set S(t) and an action space set A(t) of the intelligent agent at each moment t, and a reward value rₜ obtained by adopting an action aₜ in each state sₜ are defined.

Each state sₜ refers to all elements of the state space S(t) at the moment t, and each action aₜ refers to all elements of the action space A(t) at the moment t:

$$S ( t ) = \{ {P}_{P V} ( t ) , {P}_{Load} ( t ) , {H}_{Load} ( t ) , t , {c}_{Grid} ( t ) , SO C ( t ) , SO T ( t ) , {P}_{C H P} ( t ) \}$$

wherein, P_{PV}(t) is an output of a photovoltaic unit at the moment t, P_{Load}(t) is a user electric load at the moment t, H_{Load}(t) is a user thermal load at the moment t, c_{Grid}(t) is a real-time electricity price, SOC(t) is an electricity storage state at the moment t, SOT(t) is a heat storage state at the moment t, and P_{CHP}(t) is an electric power output of a cogeneration unit at the moment t; and

$$A ( t ) = \{ {P}_{C H P} ( t ) , {H}_{E B} ( t ) , {P}_{E S S} ( t ) , {H}_{T S S} ( t ) , {H}_{G B} ( t ) \}$$

H_{EB}(t) is output power of an electric boiler at the moment t, P_{ESS}(t) is electric discharge power of an electricity storage system at the moment t, H_{TSS}(t) is heat release power of a heat storage system at the moment t, and H_{GB}(t) is output power of a gas boiler at the moment t.

The intelligent agent takes the maximization of reward value as a basis of action, and takes the minimization of system cost as a goal in an integrated energy system economic dispatching problem, so that a reward value function is defined as taking a negative of the objective function, and meanwhile, an economic impact caused by getting out of the constraints is added to the reward value function as a penalty function to establish a reward function rₜ:

$${r}_{t} = - {β}_{c} C ( t ) - {β}_{g} G ( t )$$

wherein, C(t) represents a sum of all costs in each dispatching time interval t, G(t) represents a sum of costs of the system without the constraints in each dispatching time interval t, and β_{c} and β_{g} are coefficients of a cost function and a penalty function, which are respectively set to be 1 and 0.5.

Parameters of a neural network and an experience pool are initialized: parameters ϕ, θ₁ and θ₂ of a strategy network π(s|ϕ), a first value network Q(s,a|θ₁) and a second value network Q(s,a|θ₂) are randomly initialized into and ϕ₀, θ_{1_0} and θ_{2_0}, and values are assigned to the parameters ϕ′, θ′₁ and θ′₂ of the target strategy network π′(s|ϕ′), the first target value network Q′(s,a|θ′₁) and the second target value network Q′(s,a|θ′₂). The experience pool, as a quadruple (sₜ,aₜ,rₜ,sₜ₊₁), is used for storing the state sₜ, the action aₜ, the reward rₜ and a next state sₜ₊₁ generated by an interaction between the intelligent agent and an environment.

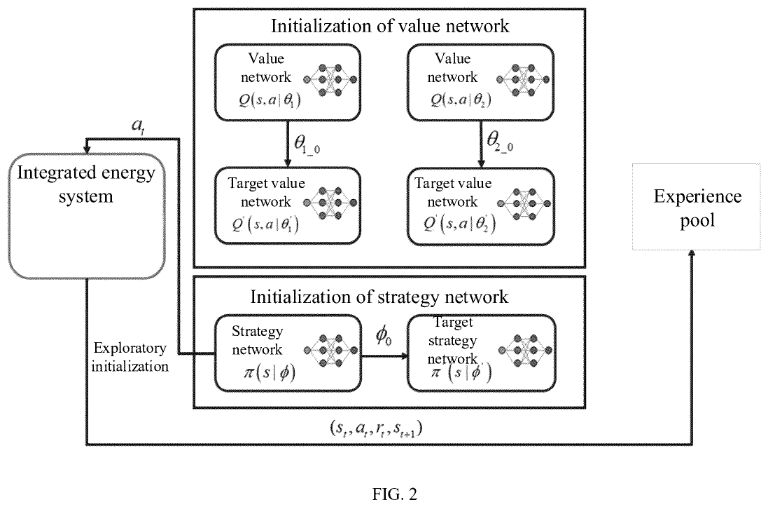

The experience pool is filled by exploratory initialization to provide diversified initial experience for the intelligent agent, and action selection is defined as follows:

$${a}_{t} = \{ \begin{matrix}Random action & μ \\ Strategy action & 1 - μ\end{matrix}$$

wherein, μ is an exploration probability, and an initial value of the exploration probability is set to be 1, which is gradually decreased with time t, so as to ensure that different experience is collected in an initial stage. The initialization of the neural network structure and the experience pool is as shown in FIG. 2.

In step 2, a group of data (sₜ,aₜ,rₜ,sₜ₊₁) are randomly selected from the experience pool, and the target strategy network π′(s|ϕ′) is used to calculate a corresponding action aₜ₊₁ in the state sₜ₊₁:

$${a}_{t + 1} = {π}^{′} ( {s}_{t + 1} \vert {ϕ}^{′} )$$

a noise needs to be added to the action aₜ₊₁ to make the network more stable:

$${a}_{t + 1} = {a}_{t + 1} + ε$$

wherein, ε is an action noise, an initial value of the action noise is set to be 0.999, and is gradually decreased to 0 with a number of training rounds, and the value of the action noise cannot exceed a maximum value of action: ε˜clip(N(0, σ),−aₘₐₓ, aₘₐₓ).

TD_target y is calculated:

$$y = {r}_{t} + γ {min}_{i = 1 , 2} {Q}_{i}^{′} ( {s}_{t + 1} , {a}_{t + 1} \vert {θ}_{i}^{′} )$$

min_{i=1,2}Q′ᵢ(sₜ₊₁,aₜ₊₁|θ′ᵢ) represents minimum values of outputs of two target value networks Q′₁(sₜ₊₁,aₜ₊₁|θ′₁) and Q′₂(sₜ₊₁,aₜ₊₁|θ′₂) and γ is a weight coefficient, which is set to be 0.99 in the embodiment.

A sum of mean square errors of outputs of two value networks Q_{θ}_{₁}(sₜ,aₜ) and Q_{θ}_{₂}(sₜ,aₜ) with y is calculated as a loss function Qₗₒₛₛ:

$${Q}_{l o s s} = {\sum }_{i = 1}^{2} m s e ( {Q}_{i} ( {s}_{t} , {a}_{t} \vert {θ}_{i} ) - y )$$

parameters of the two value networks are updated by a gradient descent algorithm.

In step 3, by using delayed learning, an update frequency of a strategy network π(s|ϕ) is set to be less than that of a value network Q_{θ}_{ᵢ}(s,a|θᵢ), so as to ensure that an estimation error is reduced before updating the strategy. In the embodiment, the value network Q_{θ}_{ᵢ}(s,a|θᵢ) is updated thrice and then the strategy network T (s|θ) is updated once in the network training process.

The strategy network π(s|ϕ) outputs a new action aₜ₊₁ according to the current state sₜ:

$${a}_{t + 1} = π ( {s}_{t} \vert ϕ )$$

A value q_{i_t+1} of the new action aₜ₊₁ is calculated through the value network Q_{θ}_{ᵢ}(s,a|θᵢ):

$${q}_{i \_ t + 1} = {Q}_{i} ( {s}_{t} , {a}_{t + 1} \vert {θ}_{i} )$$

An average value of the outputs of the two value networks is calculated and an opposite value is taken as a loss function πₗₒₛₛ of the strategy network:

$${π}_{l o s s} = - \frac{{\sum }_{i = 1}^{2} {q}_{i \_ t + 1}}{2}$$

Finally, the strategy network π(s|ϕ) is updated by a gradient ascent algorithm.

In step 4, the reward value rₜ in the Markov decision making process is taken as a measurement index, rₜ represents an opposite value of a total dispatching cost of this round in the integrated energy system economic dispatching, and the larger the opposite value, the lower the dispatching cost, and the better the decision made by the intelligent agent in this round. Before the soft update of the target network, a reward value rₜ of a current round is compared with a reward value rₜ₋₃ of the last round of soft update, and if the reward value rₜ of the current round is large, parameters of the target network of the current round are effective experience, and a weight of the effective experience is increased during soft update. A variable time constant τₜ is set according to the reward value:

$${τ}_{t} = \{ \begin{matrix}{τ}_{t - 3} + ρ & ( {r}_{t} < {r}_{t - 3} ) \\ {τ}_{t - 3} & ( {r}_{t} = {r}_{t - 3} ) \\ {τ}_{t - 3} - ρ & ( {r}_{t} > {r}_{t - 3} )\end{matrix}$$

wherein, t represents an update moment of the current round of the target network, and t−3 represents an update moment of the last round of the target network; and τₜ₋₃ is a variable time constant used for the last round of update, an initial value of the variable time constant is 0.005, and ρ is a variation of the time constant, which is set to be 0.0001. The variable time constant τₜ satisfies that:

$${τ}_{min} < {τ}_{t} < {τ}_{max}$$

wherein, τₘₐₓ is 0.01, and τₘᵢₙ is 0.0001.

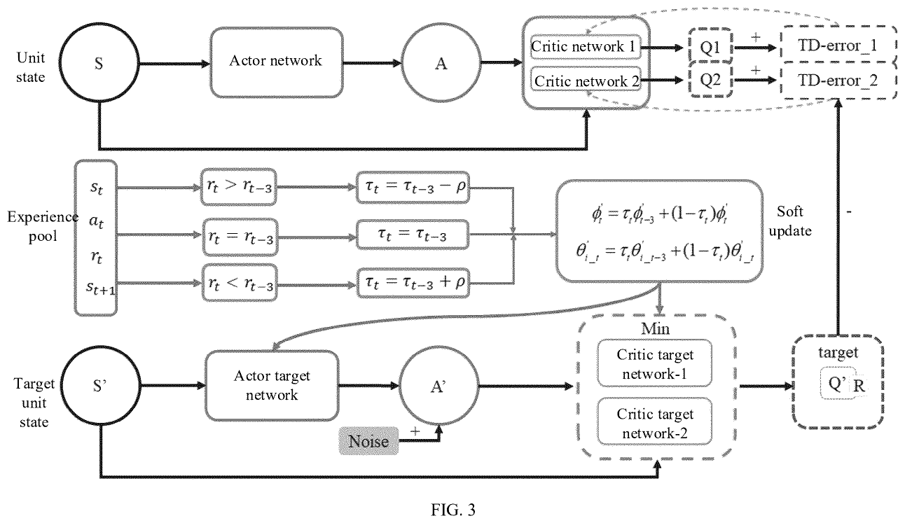

A target strategy network and a target value network are updated according to the variable time constant τₜ, as shown in FIG. 3:

$$\begin{matrix}{ϕ}_{t}^{′} = {τ}_{t} {ϕ}_{t - 3}^{′} + ( 1 - {τ}_{t} ) {ϕ}_{t}^{′} \\ {θ}_{i\_t}^{′} = {τ}_{t} {θ}_{i\_t - 3}^{′} + ( 1 - {τ}_{t} ) {θ}_{i\_t}^{′}\end{matrix}$$

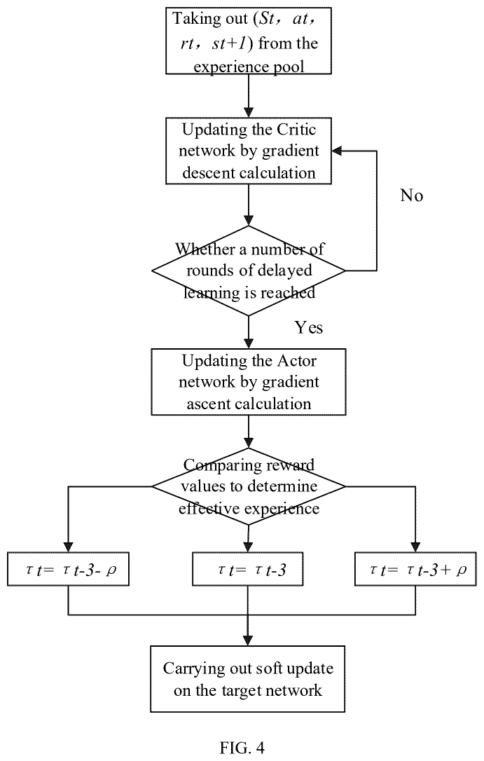

In step 5, the steps 2 to 4 are repeated, the intelligent agent is repeatedly iteratively trained to learn how to make the best decision in different situations, so as to maximize a reward function. A flow chart of training of the model is as shown in FIG. 4.

In step 6, the trained intelligent agent model is saved, and the model is used for intra-day dispatching of the integrated energy system, so as to realize optimal economic cost operation of the integrated energy system.

In order to verify the effectiveness of the method, 7 summer working days and 4 summer holidays, in a total of 11 days, are randomly selected for a dispatching simulation experiment, and results are as shown in Table 1:

TABLE 1

| | | | Operation cost ($) | | |
|---|---|---|---|---|---|
| Weather type | | | Traditional | The | Cost decrease |
| Day type | | | method | method | amount (%) |
| Day 1; | Sunny | Working | 537.35 | 506.24 | 5.79 |
| | weather | day | | | |
| Day 2; | Cloudy | Working | 510.33 | 492.74 | 3.45 |
| | weather | day | | | |
| Day 3; | Sunny | Working | 503.14 | 487.39 | 3.13 |
| | weather | day | | | |
| Day 4; | Cloudy | Working | 505.99 | 483.08 | 4.53 |
| | weather | day | | | |
| Day 5; | Sunny | Working | 503.08 | 479.04 | 4.79 |
| | weather | day | | | |
| Day 6; | Sunny | Working | 504.90 | 486.57 | 3.63 |
| | weather | day | | | |
| Day 7; | Sunny | Working | 505.43 | 487.89 | 3.47 |
| | weather | day | | | |
| Day 8; | Cloudy | Holiday | 415.31 | 394.33 | 5.05 |
| | weather | | | | |
| Day 9; | Sunny | Holiday | 415.14 | 395.34 | 4.77 |
| | weather | | | | |
| Day 10; | Sunny | Holiday | 413.12 | 393.54 | 4.74 |
| | weather | | | | |
| Day 11; | Sunny | Holiday | 415.90 | 396.70 | 4.62 |
| | weather | | | | |

7 winter working days and 4 winter holidays, in a total of 11 days, are randomly selected for a dispatching simulation experiment, and results are as shown in Table 2:

TABLE 2

| | | | Operation cost ($) | | |
|---|---|---|---|---|---|
| Weather type | | | Traditional | The | Cost decrease |
| Day type | | | method | method | amount (%) |
| Day 1; | Sunny | Working | 530.88 | 503.92 | 5.08 |
| | weather | day | | | |
| Day 2; | Cloudy | Working | 529.30 | 502.62 | 5.04 |
| | weather | day | | | |
| Day 3; | Sunny | Working | 523.33 | 500.90 | 4.29 |
| | weather | day | | | |
| Day 4; | Cloudy | Working | 520.06 | 499.47 | 3.96 |
| | weather | day | | | |
| Day 5; | Sunny | Working | 528.36 | 495.58 | 5.63 |
| | weather | day | | | |
| Day 6; | Sunny | Working | 536.04 | 504.75 | 5.84 |
| | weather | day | | | |
| Day 7; | Sunny | Working | 536.33 | 502.31 | 6.34 |
| | weather | day | | | |
| Day 8; | Cloudy | Holiday | 500.01 | 470.23 | 5.96 |
| | weather | | | | |
| Day 9; | Sunny | Holiday | 508.23 | 473.68 | 6.21 |
| | weather | | | | |
| Day 10; | Sunny | Holiday | 502.52 | 477.14 | 5.05 |
| | weather | | | | |
| Day 11; | Sunny | Holiday | 506.99 | 480.00 | 5.32 |
| | weather | | | | |

The above tables show the operation costs of the integrated energy system after optimized dispatching by the method and the traditional method in different seasons, different weathers and different power consumption scenarios. It can be seen that the operation cost of the system can be effectively reduced by the method in different seasons and weathers, and the method is also applicable in the face of different load demands in working days and holidays.

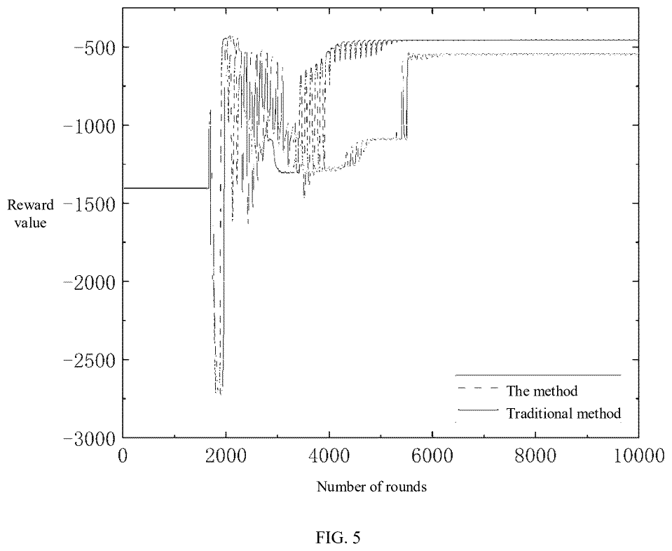

The reward value in the training process is taken as an evaluation goal, and convergence effects of the traditional method and the method are compared in the same environment. As shown in FIG. 5, a number of rounds of convergence of the method is lower than that of the traditional method, and a final reward value of the method is also higher than that of the traditional method. In order to avoid the contingency of the experiment, the above experiment is repeated for many times, the numbers of rounds of convergence of the two methods are recorded, and results are as shown in Table 3:

TABLE 3

| | Number of rounds | | |
|---|---|---|---|
| | required (*20) | | Decrease amount |
| Number of | The | Traditional | of number of |
| experiments | method | method | rounds (%) |
| 1 | 5425 | 5985 | 9.36 |
| 2 | 5498 | 6062 | 9.30 |
| 3 | 5573 | 5927 | 5.97 |
| 4 | 5432 | 6054 | 10.27 |
| 5 | 5589 | 5998 | 7.31 |
| Average | 5503 | 6005 | 8.36 |

It can be seen from the data in Table 3 that, the method can achieve convergence with a fewer number of rounds in many experiments, and the effect is remarkable.

1. An optimized dispatching method for an integrated energy system comprising a photovoltaic unit, a cogeneration unit, an electricity storage system, a heat storage system, an electric boiler and a gas boiler, the method comprising:
establishing an integrated energy system model and describing an optimized dispatching process as a Markov decision making process;
setting an objective function as an operation cost of each unit, and establishing the following optimized objective function:
$$F = min {\sum }_{t}^{T} ( {C}_{E} ( t ) + {C}_{CHP} ( t ) + {C}_{ESS} ( t ) + {C}_{GB} ( t ) )$$
wherein, C_{E}(t), C_{CHP}(t), C_{ESS}(t) and C_{GB}(t) are respectively an electricity purchasing cost, a cogeneration cost, an energy storage system operation cost and a gas boiler operation cost at the moment t, in a unit of $; and T is a step number of time in a single dispatching period; and
applying constraints comprising an electric power balance constraint, a thermal power balance constraint, a cogeneration unit operation constraint, an electricity storage system operation constraint, a heat storage system operation constraint, a main power grid electricity purchasing constraint, an electric boiler constraint and a gas boiler constraint;
training a neural network by a double-delay depth deterministic strategy gradient algorithm based on real-time output of the photovoltaic unit and storage states of the electricity storage system and the heat storage system,
before carrying out soft update on a target network, comparing a reward value rₜ of a current round and a reward value rₜ₋₃ of the last round of soft update, and setting a variable time constant τₜ:
$${τ}_{t} = \{ \begin{matrix}{τ}_{t - 3} + ρ & ( {r}_{t} < {r}_{t - 3} ) \\ {τ}_{t - 3} & ( {r}_{t} = {r}_{t - 3} ) \\ {τ}_{t - 3} - ρ & ( {r}_{t} > {r}_{t - 3} )\end{matrix}$$
wherein, τₜ₋₃ is a variable time constant used in the last round of update, τ₀=0.005, and ρ is a variation of the time constant; and t represents an update moment of the current round of the target network, and t−3 represents an update moment of the last round of the target network;
updating a target strategy network and a target value network according to the variable time constant τₜ:
$$\begin{matrix}{ϕ}_{t}^{′} = {τ}_{t} {ϕ}_{t - 3}^{′} + ( 1 - {τ}_{t} ) {ϕ}_{t}^{′} \\ {θ}_{i\_t}^{′} = {τ}_{t} {θ}_{i\_t - 3}^{′} + ( 1 - {τ}_{t} ) {θ}_{i\_t}^{′}\end{matrix}$$
wherein, ϕ′ₜ and θ′_{i_t} respectively represent a parameter of the target strategy network and a parameter of the target value network after update in the current round, and ϕ′ₜ₋₃ and θ′_{i_t-3} respectively represent a parameter of the target strategy network and a parameter of the target value network after update in the last round; and
performing intra-day dispatching of the integrated energy system by the trained neural network to control the cogeneration unit, the electricity storage system, the heat storage system, the electric boiler, and the gas boiler.

2. (canceled)

3. The method according to claim 1, wherein the optimized dispatching process of the integrated energy system is described as the Markov decision making process, and a state space set S(t) and an action space set A(t) of an intelligent agent at each moment t, and the reward value rₜ obtained by adopting an action aₜ in each state sₜ are defined:
$$\begin{matrix}S ( t ) = \{ {P}_{PV} ( t ) , {P}_{Load} ( t ) , {H}_{Load} ( t ) , t , {c}_{Grid} ( t ) , SOC ( t ) , SOT ( t ) , {P}_{CHP} ( t ) \} \\ A ( t ) = \{ {P}_{CHP} ( t ) , {H}_{EB} ( t ) , {P}_{ESS} ( t ) , {H}_{TSS} ( t ) , {H}_{GB} ( t ) \} \\ {r}_{t} = - {β}_{c} C ( t ) - {β}_{g} G ( t )\end{matrix}$$
wherein, P_{PV}(t) is an output of a photovoltaic unit at the moment t, P_{Load}(t) is a user electric load at the moment t, H_{Load}(t) is a user thermal load at the moment t, c_{Grid}(t) is a real-time electricity price, SOC(t) is an electricity storage state at the moment t, SOT(t) is a heat storage state at the moment t, and P_{CHP}(t) is an electric power output of a cogeneration unit at the moment t; H_{EB}(t) is output power of an electric boiler at the moment t, P_{ESS}(t) is electric discharge power of an electricity storage system at the moment t, H_{TSS}(t) is heat release power of a heat storage system at the moment t, and H_{GB}(t) is output power of a gas boiler at the moment t; and C(t) represents a sum of all costs in each dispatching time interval t, G(t) represents a sum of costs of the system without the constraints in each dispatching time interval t, and β_{c} and β_{g} are coefficients of a cost function and a penalty function.

4. The method according to claim 1, wherein parameters of a strategy network π(s|ϕ), a first value network Q(s,a|θ₁) and a second value network Q(s,a|θ₂) are initialized, and a value is assigned to the target network; and
a quadruple (sₜ, aₜ,rₜ,sₜ₊₁) is set for storing the state sₜ, the action aₜ, the reward rₜ, and a next state sₜ₊₁ generated by an interaction between the intelligent agent and an environment; and an experience pool is filled by exploratory initialization, and an action selection method is defined as follows:
$${a}_{t} = \{ \begin{matrix}\text{?} & µ \\ \text{?} & 1 - µ\end{matrix}$$
$$\text{?} \text{indicates text missing or illegible when filed}$$
wherein, μ is an exploration probability, and an initial value of the exploration probability is set to be 1, which is gradually decreased with time t.

5. The method according to claim 4, wherein the value network Q_{θ}_{ᵢ}(s,a|θᵢ) is updated thrice and then the strategy network τ(s|ϕ) is updated once in the network training process.

6. The method according to claim 5, wherein an updating method of the value network is as follows:
a group of data (sₜ,aₜ,rₜ,sₜ₊₁) are randomly selected from the experience pool, and the target strategy network τ′(s|ϕ′) is used to calculate a corresponding action aₜ₊₁ in the state sₜ₊₁:
$${a}_{t + 1} = {π}^{′} ( {s}_{t + 1} \vert {ϕ}^{′} )$$
a noise needs to be added to the action aₜ₊₁:
$${a}_{t + 1} = {a}_{t + 1} + ε$$
wherein, ε is an action noise, and a value of the action noise does not exceed a maximum value of the action and is gradually decreased to 0 with a number of training rounds; and
a sum of mean square errors of outputs of two value networks Q_{θ}_{₁}(sₜ,aₜ) and Q_{θ}_{₂}(sₜ,aₜ) with y is calculated as a loss function Qₗₒₛₛ:
$$\begin{matrix}{Q}_{loss} = {\sum }_{i = 1}^{2} mse ( {Q}_{i} ( {s}_{t} , {a}_{t} \vert {θ}_{i} ) - y ) \\ y = {r}_{t} + γ {min}_{i = 1 , 2} {Q}_{i}^{′} ( {s}_{t + 1} , {a}_{t + 1} \vert {θ}_{i}^{′} )\end{matrix}$$
wherein, min_{i=1,2}Q′ᵢ(sₜ₊₁,aₜ₊₁|θ′ᵢ) represents minimum values of outputs of two target value networks Q′₁(sₜ₊₁,aₜ₊₁|θ′₁) and Q′₂(sₜ₊₁,aₜ₊₁|θ′₂) and γ is a weight coefficient; and parameters of the two value networks are updated by a gradient descent algorithm.

7. The method according to claim 5, wherein an updating method of the strategy network is as follows:
the strategy network π(s|ϕ) outputs a new action aₜ₊₁ according to the current state sₜ:
$${a}_{t + 1} = π ( {s}_{t} \vert ϕ )$$
a value q_{i_t+1} of the new action aₜ₊₁ is calculated through the value network Q_{θ}_{ᵢ}(s,a|θᵢ);
$${q}_{i\_t + 1} = {Q}_{i} ( {s}_{t} , {a}_{t + 1} \vert {θ}_{i} )$$
an average value of the outputs of the two value networks is calculated and an opposite value is taken as a loss function πₗₒₛₛ of the strategy network:
$${π}_{loss} = - \frac{{\sum }_{i = 1}^{2} {q}_{i\_t + 1}}{2}$$
the strategy network π(s|ϕ) is updated by a gradient ascent algorithm.

8. The method according to claim 3, wherein parameters of a strategy network π(s|ϕ), a first value network Q(s,a|θ₁) and a second value network Q(s,a|θ₂) are initialized, and a value is assigned to the target network; and
a quadruple (sₜ,aₜ,rₜ,sₜ₊₁) is set for storing the state sₜ, the action aₜ, the reward rₜ and a next state sₜ₊₁ generated by an interaction between the intelligent agent and an environment; and an experience pool is filled by exploratory initialization, and an action selection method is defined as follows:
$${a}_{t} = \{ \begin{matrix}\text{?} & µ \\ \text{?} & 1 - µ\end{matrix}$$
$$\text{?} \text{indicates text missing or illegible when filed}$$
wherein, μ is an exploration probability, and an initial value of the exploration probability is set to be 1, which is gradually decreased with time t.
